(19) United States
(12) Patent Application Publication
(10) Pub. No.: US 2004/0226482 A1
(43) Pub. Date: Nov. 18, 2004

(54) Colored cement composition

(76) Inventors: Charles J. Johansen JR., Katy, TX (US); Ernest D. Hollas, Weimar, TX (US)

Correspondence Address: Kenneth F. Florek, Esq., Hedman & Costigan, P.C., 1185 Avenue of the Americas, New York, NY, 10036, US

(21) Appl. No.: 10/776,958

(22) Filed: Feb. 11, 2004

Related U.S. Application Data
(63) Continuation-in-part of application No. 10/105,718, filed on Mar. 25, 2002, now Pat. No. 6,692,565.
Application No. 10/105,718 is a continuation-in-part of application No. 09/716,399, filed on Nov. 20, 2000, now abandoned.

(51) Int. Cl. C04B 14/00

(52) U.S. Cl. 106/712; 106/733

(57) ABSTRACT

A colored cement composition and method for preparing colored cement for use as mortars, grouts, stuccos or pool plasters that uses a colored cement produced from clinkers formed with pigment prior to sintering and a naturally occurring colored or pigmented inert filler.

### REFERENCE TO RELATED APPLICATION

The present application is a continuation in part of U.S. patent application Ser. No. 10/105,718, filed Mar. 25, 2002, now allowed, which is a continuation in part of U.S. patent application Ser. No. 09/716,399, filed Nov. 20, 2000, now abandoned.

### FIELD OF THE INVENTION

The present invention relates to a composition and a method for preparing colored cement for use as mortars (such as thin set mortars and brick mortars), grouts, stuccos or pool plasters. More specifically, the invention relates to a cement composition comprising a colored cement produced from clinkers formed with pigment prior to sintering, water and inert filler. Additionally, the inert filler may comprise an effective amount of a colored inert filler.

### BACKGROUND OF THE INVENTION

As is well known in the art, cement is produced by pulverizing clinkers consisting essentially of hydraulic calcium silicates, usually containing one or more of the forms of calcium sulfate as an inter ground addition with other components. Clinkers are nodules, with diameters of 0.2-1.0 inch, of a sintered material that is produced when a raw mixture of predetermined composition is heated to high temperature. Clinkers used in the manufacture of cement are often produced using limestone, shale and other naturally occurring materials with other components and are generally white or gray. As such, the cements generally available are considered “uncolored.”

The addition of pigments or dyes to uncolored cement is well known in the art to achieve a colored cement composition. For example, U.S. Pat. No. 4,204,876 teaches a pigment containing thixotropic slurry that can be stored in drums for 6-12 months by a cement contractor and used in a batching system. Similarly U.S. Pat. No. 5,558,708 and U.S. Pat. No. 5,846,315 disclose a method, composition and system for preparing pigmented cement compositions employing an aqueous component that contains a pigment and a dry powdered component. Other methods for preparing colored or pigmented cement compositions are described in, U.S. Pat. No. 5,199,986, U.S. Pat. No. 3,667,976, U.S. Pat. No. 4,946,505, United Kingdom Patent No. 2,183,626, German Patent No. 3,709,909 and WO 92/12102 which are incorporated herein by reference.

The 3M company also sells a product known as COLORQUARTZ™ aggregate which consists of quartz particles that are ceramically coated by a process that permanently bonds inorganic pigments to the quartz particle. It is believed that these particles are prepared by firing, i.e. intense heating, at temperatures above 600° F. The particles are available in an S grade, which are spherical shaped particles and a T grade which are trowable particles. These ceramically coated quartz particles have a large particle size, typically around 12-70 mesh or larger. The ceramically coated granules can be added to cement compositions such as pool plasters or flooring compositions to provide specks of color throughout the pool or flooring. The ceramically coated granules are very expensive and fail to provide a uniform color to the cement composition.

Attempts have also been made to prepare a gray cement composition by employing a naturally occurring gray calcium carbonate product as an inert filler. These attempts have not proved acceptable because the naturally occurring gray calcium carbonate exhibits a very high sulfur content that may adversely affects the final properties of the cured product. Other attempts at preparing colored cement compositions have included crushing naturally occurring colored marble, such as a green marble, and using the crushed colored marble as the inert filler in the cement composition. This process is quite expensive, the colors and hues are limited and additional pigment may be required.

With the exception of the naturally occurring gray calcium carbonate and the crushed colored marble, all the aforementioned prior methods for preparing colored cement require the user to modify the well established methods for preparing cement compositions by either changing the components used in the composition or requiring the addition of extra components such as pigments. These changes often increase the expense and time required for a project and are met with great resistance by the industry. The use of naturally occurring colored marble will add greatly to the expense of any project due to the shipping and handling costs associated with locating the marble and shipping the marble from the quarry to a job site which is often hundreds if not thousands of miles away from the quarry.

A further disadvantage of the prior methods for preparing colored cement is that the pigment used to prepare the colored cement is typically dispersed throughout the composition rather than attached to any of the main components in the composition. In this regard, the mere dispersion of the pigment allows it to be easily leached while the cement is hydrating. In addition, the dispersion of pigments in cement compositions often results in color differences between batches due to variations in the mixing procedure, gauging water variation or inaccurate weighing of the pigment. A further disadvantage of the free pigment in the system is that during application of the cement, the pigment tends to float to the surface of the cement composition, causing a non-uniform appearance.

A further disadvantage of the prior art methods for making colored cement and non-colored cement is the employment of sand. It has recently been reported that raw, uncoated sand presents a health risk to humans. The primary health risk is from the inhalation of respirable silica dust that can cause silicosis. Silicosis is a pulmonary fibrosis, i.e., causes the development of scar tissue in lungs, which can be progressive and disabling to the point of causing death.

The International Agency for Research on Cancer (IRAC) has categorized sand as a Class 2A carcinogen. A Class 2A carcinogen is one in which there is limited evidence for carcinogenicity in humans and sufficient evidence for carcinogenicity in experimental animals.

Due to the health risks associated with the use of sand in cement compositions, it is an object of the present invention to provide a cement composition that significantly reduces the carcinogenic risk.

It is also an object of the present invention to provide a composition and method for preparing colored cement that does not substantially increase the cost of a cement composition.

It is a further object of the present invention to provide a composition and method for preparing colored cement that can be easily incorporated into existing methods of manufacturing.

It is an additional object of the present invention to provide a composition and method for preparing colored cement that can provide a final cured cement product that exhibits a more uniform and permanent color that is UV stable and chemically resistant.

It is still a further object of the present invention to provide a method of preparing colored cement that prevents the cement workers from breathing and contacting free pigments that often contain toxic heavy metals.

### SUMMARY OF THE INVENTION

These and other objects of the present invention are achieved by a composition comprising colored cement produced from clinkers formed with pigment prior to sintering, water and inert filler.

By adding the pigment to the predetermined clinker composition prior to sintering, the pigment is bound to the cement product in the sintering stage. Thus, the color is infused into the clinker prior to pulverizing, rather than added to the cement after the clinker is pulverized into the cement product. This creates truly colored cement and not merely cement with pigment added. All other aspects of the production of the colored cement are the same as conventionally known in the art for producing uncolored cement.

As will be further discussed below, the colored cement composition may use both the colored cement produced from clinkers formed with pigment prior to sintering and uncolored cement to modify the final color of the resulting cement composition.

The inert filler can be naturally colored, i.e., white or gray calcium carbonate, beige sand, any color crushed marble, such as blue, green, black, tan, etc., or any other suitable naturally colored inert filler. In another embodiment, the color associated with the inert filler is man made, comprising an effective amount of a pigmented inert filler, having been colored by dying the inert filler, chemically bonding a pigment to the inert filler or permanently coating a pigment onto the inert filler.

Depending on the color of the pigment component used in the clinker composition for forming the clinker prior to sintering and pulverizing, the resulting colored cement will have a distinct color that is integral to the cement.

The pigment or dye coating on the inert filler, when a man made pigmented inert filler is used, must be permanently bonded to the inert filler or impart a superhydrophobic property to the inert filler. When the pigment or dye coating is permanently bonded to the inert filler it is preferred that the pigment or dye coating be chemically bonded to the inert filler such as by means of an epoxy or siloxane linkage. The application of the pigment or dye coating should be conducted at temperatures below about 600° F., and preferably below 500° F., however higher temperature processes may be used if suitable to provide a permanent color coating.

When the pigment or dye coating imparts a superhydrophobic property to the inert filler, the coating should comprise submicron silica particles that have been treated for water repellency. Examples of superhydrophobic coatings are described in U.S. Pat. Nos. 5,890,907 and 3,592,679 that are incorporated herein by reference.

The present invention also has the surprising benefit of creating a safe and non-carcinogenic cement composition.

An especially preferred man made pigmented inert filler is a commercial product known DEK ROK surface aggregates, available from Clifford W. Estes Co. of Lyndhurst, N.J. The DEK ROK product is believed to comprise sand, the grains of which are coated with much finer submicron particles that have been surface treated for water repellency as taught in U.S. Pat. No. 3,592,679. The submicron silica powders are available commercially under the trade name CABOSIL from the Cabot Corp. of Boston, Mass. Such fine silica powders, surface treated with hexamethyldisilizane are commercially available under the tradename Tullannox from Tulco Corp. of Ayer, Mass. Another preferred pigmented inert filler is commercially available from Sandtastik, Inc. of Niagra Falls, N.Y., under the trade name SANDTASTIK. It is believed that the SANDTASTIK product comprises sand wherein the pigment has been chemically bonded to the sand.

The effective amount and size of the pigmented inert filler will vary depending upon the color that is desired for the final product and the application. Typically the effective amount of the pigmented inert filler will range from 5-100 weight percent, preferably 15-100 weight percent and most preferably 25-100 weight percent based on the total weight of the inert filler employed in the particular application. To obtain the non-carcinogenic properties of the present invention, the pigmented inert filler will comprise 100 weight percent of the inert filler. Use of 100 weight percent of pigment inert filler is especially preferred.

The cement composition may further comprise conventional additives that are commonly known in the industry such as latexes, liquefiers, reinforcing fibers, preservatives, antifoaming agents, setting aids, viscosity control agents, plasticizers, anti-slumping agents, moisture retaining additives or mixtures of the foregoing.

In a preferred embodiment, the cement composition comprises about 5 to about 70 weight percent, most preferably about 10 to about 55 weight percent, of colored cement produced from clinkers formed with pigment prior to sintering; about 5 to about 65 weight percent, most preferably about 10 to about 50 weight percent, of an inert filler which optionally includes a naturally occurring or man made pigmented inert filler; about 10 to 40 weight percent, most preferably about 15 to 30 weight percent water and 0 to about 5 weight percent, preferably 0 to about 2 weight percent of non-bonded pigment. In a preferred embodiment, no free or non-bonded pigment is needed to create a cement composition with a uniform color because the pigmented inert filler contains a small amount of fines as will be discussed below. All the foregoing weight percents are based on the total weight of the composition.

The present invention also comprises a method for preparing a colored cement composition that comprises mixing the colored cement produced from clinkers formed with pigment prior to sintering and an inert filler with water, and 0 to about 5 weight percent, preferably 0 to about 2 weight percent, of free or non-bonded pigment to prepare a colored cement composition.

### DETAILED DESCRIPTION OF THE INVENTION

The cement employed in the present invention is preferably Type I or Type II Portland cement produced from clinkers formed with pigment prior to sintering. However, other types of Portland cement and/or other types of cements, including but not limited to aluminous cement, Type III high early strength cement, Portland blast furnace slag cement or Portland pozzolan cement may also be used, as long as it is produced from clinkers formed with pigment prior to sintering. In all other respects, production of the colored cement used with the present invention is the same as is well known in the art.

Inert fillers that may be used in the present invention comprise aggregate filler, fine filler or a combination of aggregate and fine fillers. The inert filler additive may be silica sand, limestone, perlite, volcanic aggregate, alumina trihydrate, ground quartz, volcanic ash, fine sand, talc, mica, clays, calcium carbonate (marble dust) or other clean inert material or mixtures of the foregoing. The inert filler of the cement component may comprise one, or a combination of the above-identified clean inert materials. Any of the above-described inert filler materials may have naturally occurring color, may be white or may be dyed, bonded or coated with a pigmented material to form the inert filler for use in the present invention.

When a man made pigmented inert filler is used the attaching, i.e., dying, bonding or coating, of a pigment onto the inert filler can be accomplished by any means commonly known in the chemical industry, however, the process chosen should result in a pigmented inert filler where the pigment will not be released or dissolved in an aqueous media or an aqueous environment such as a swimming pool. The man made pigmented inert filler should also withstand normal day to day cleaning with conventional household cleaning compounds used in accordance the manufacturer's specifications.

The process of attaching the pigment to the inert filler, when man made pigmented inert filler is used, should occur at temperatures less than 600° F., preferably below 500° F. The man made pigmented inert filler should be prepared prior to its incorporation into the cement composition and most preferably prior to its sale for incorporation into a cement composition or delivery to a job site. A preferred method for preparing the pigmented inert filler is the method employed by Clifford W. Estes Co., of Lyndhurst, N.J. to produce its superhydrophobic product sold under the trade names ULTRASTONE, WILMAR SPECTRASTONE, PERMA COLOR SURFACE AGGREGATE, MAGIC SAND and DEC ROC products. Another preferred pigmented product is commercially available from Sandtastik, Inc. of Niagara Falls, N.Y. under the trade name SANDTASTIK.

Still another preferred man made pigmented product is a commercial product known as “SCENIC SANDS ” available from Activa Products, Inc., of Marshall, Tex. USA. It is believed that the process employed by Activa Products to manufacture the colored sand involves the spraying of a water based pigment composition onto sand or other inert particles such as calcium carbonate and heating, but not ceramically firing, the sprayed particles to remove the water. Once the water is removed, the pigment composition is permanently bonded to the sand. Applicant has attempted to coat calcium carbonate with the pigment composition and process employed by Activa to prepare the SCENIC SANDS product. However, applicant's attempt was not successful for the present invention because the coating quickly washed off the calcium carbonate when the coated calcium carbonate was placed in water.

When sand is used as the inert filler and the reduced carcinogenic properties of the present invention are desired, all of the sand used in the composition should be sand that has been coated with a pigment composition. A preferred coated sand is obtained by the process used by Clifford W. Estes Co. to produce its ULTRASTONE, WILMAR SPECTRASTONE, PERMA COLOR SURFACE AGGREGATE, MAGIC SAND and DEC ROC products. The use of coated sand reduces the development of respirable silica dust that could be inhaled and lead to silicosis, thereby rendering the cement composition significantly less carcinogenic.

When pigmented inert filler is used it should have a particle size between 1 and 350 mesh. The actual range of particle sizes will depend upon the particular application for the colored cement composition. In order to prevent the pigmented inert filler from creating a cement composition with a non-uniform color, the pigmented inert filler should comprise a range of particle sizes, including filler fines (particles that are smaller than 100 mesh, preferably smaller than 150 mesh and most preferably particles smaller than 200 mesh). More specifically, the pigmented inert filler should contain at least about 5 weight percent, and preferably at least about 10 weight percent, of pigmented inert filler fines, as more particularly discussed below.

The amount and size of inert filler fines will depend upon the particular application for the cement composition. For example, if the colored cement composition includes a pigmented inert filler and will be used as a grout, the particle size of the inert filler (pigmented and non-pigmented inert filler) would preferably be between about 40 and 100 mesh with about 0-10 weight percent comprising pigmented inert filler fines (preferably smaller than 200 mesh). In the case of sanded grout, it is preferred that a large portion, i.e., about 70-95% of the inert filler have a particle size between about 45 and 60 mesh with about 0-10 weight percent comprising pigmented inert filler fines, while for non-sanded grout it is preferred that a large portion of the inert filler have a particle size between about 200 and 325 mesh.

If the colored cement composition uses pigmented inert filler and will be used as a mortar, the particle size of the inert filler is preferred to be between about 4 and 100 mesh with about 0-10% comprising pigmented inert filler fines. If the colored cement composition will be used as a stucco, the particle size of the inert filler is preferred to be between about 30 and 120 mesh with about 0-10% comprising pigmented inert filler fines, when used. If the colored cement composition is a floor surfacing or floor leveling composition, the particle size of the inert filler is preferred to be between about 20 and 180 mesh with about 0- 10% comprising pigmented inert filler fines, when pigmented inert filler is used. Furthermore, if the colored cement composition will be used as a pool plaster, the particle size of the inert filler is preferred to be between about 4 and 325 mesh with about 0-10% comprising pigmented inert filler fines.

The dye or pigment used to prepare man made pigmented inert filler, optionally used in the colored cement of the present invention, can be any type of dye or pigment that is commercially available and recommended for masonry applications from companies such as Bayer Chemicals or Davis Pigments, Inc. Free or non-bonded dye or pigment is preferably not used in the composition, with pigmented inert filler being preferred if additional color is desired. However, if the colored cement does not contain sufficient color and either pigmented inert filler is not used or does not provide a sufficient quantity of pigmented inert filler fines, a small amount of free or non-bonded pigment may be added to the composition.

The quantity of pigmented inert filler fines (particles smaller than 100 mesh, preferably smaller than 150 mesh and most preferably smaller than 200 mesh) when a pigmented inert filler is used should be about 1 to 10 weight percent of the total amount of inert filler (pigmented inert filler and/or non-pigmented inert filler), and preferably about 2 to 7 weight percent of the total amount of inert filler. The amount of fines required to prepare a cement product using pigmented inert filler with a uniform color will depend upon the actual application for the cement composition, i.e., grout or pool plaster, and the size of the fines.

Due to the use of colored cement produced from clinkers formed with pigment prior to sintering, and preparation of the pigmented inert filler, when used, prior to its sale or shipment to a job site, the applicator or mechanic will be able to practice the present invention without modifying his or her established practice of preparing cement compositions. More importantly, because the colored cement produced from clinkers formed with pigment prior to sintering has an integral color, and the pigmented inert filler, when used, is prepared prior to its sale or shipment to a job site, the present invention eliminates the potential for dyes or pigments being spilled at the job site or during storage and shipping thereby decreasing the expense caused by loss of materials and time spent cleaning the spill.

To practice the present invention, the applicator or mechanic simply mixes the colored cement produced from clinkers formed with pigment prior to sintering, water and pigmented and/or naturally occurring colored or uncolored inert filler in a conventional mixer in ratios that have traditionally been used in the industry. If free or non-bonded pigment is necessary, it is preferred that the free or non-bonded pigment be added to the inert filler prior to shipment of the inert filler to the job site.

Other conventional additives that may also be employed in the present invention to enhance the physical properties of the composition are latexes, setting aids, dispersants, surfactants, liquefiers, reinforcing fibers, preservatives, antifoaming agents, thixotropy and viscosity control agents and plasticizers. Some other miscellaneous additives that may be used are ethylene glycol, propylene glycol, neopentyl glycol, vermiculite, sodium stearate and hydroxides. These miscellaneous additives are used to improve freeze thaw stability, accelerate setting, prevent shrinkage, efflorescence or sagging, flame retardancy or hydrophobic properties of the final cement product. These property enhancing additives are present in amounts commonly known in the industry and are more fully described in U.S. Pat. No. 5,951,752, which is incorporated by reference.

As will be readily appreciated by one skilled in the art, the color of the cement composition prepared according to the foregoing method will depend upon the color of the clinkers used to produce the cement, its combination with non-colored cement is desired, and the naturally occurring or pigmented color of the inert filler. A wider range of colors can be obtained by combining predetermined amounts of two or more differently colored cements including a colored cement with an uncolored cement; differently colored cement and pigmented inert fillers; a colored cement with a particular base color and two or more differently colored pigmented inert fillers; etc.

For example, 300 lbs of a blue calcium carbonate combined with 300 lbs of a green calcium carbonate may be mixed with 376 lbs of green Portland cement and 60 lbs of water to obtain a teal green colored cement composition. This method of combining two or more differently pigmented inert fillers would preferably employ a combination chart or grid such as the one described in U.S. Pat. No. 5,362,322, which is incorporated herein by reference.

An additional method for preparing a colored cement composition that is in accordance with the present invention, comprises the following steps: (i) selecting a color from a color grid having axes with preselected component colors for the inert filler; (ii) determining the component colors from the axes of the grid corresponding to the selected color; (iii) mixing two or more predetermined portions of colored or uncolored cement produced from clinkers formed with pigment prior to sintering that correspond to the component colors from the axis of the grid to produce a selected colored cement component that corresponds to the determined color (i) selected from the grid; and (iv) mixing the selected colored cement component (iii) with water and the predetermined colored cement to obtain a cement composition with the selected color.

The present invention also relates to a method for preparing colored cement compositions such as mortars and grouts which comprises mixing a predetermined amount of water with a predetermined and prepackaged amount of a dry component comprising colored cement produced from clinkers formed with pigment prior to sintering, naturally occurring and/or pigmented inert filler, optionally non-bonded or free pigment, and optionally conventional additives. The dry component can be packaged in suitable containers such a 5, 10, 25, 50, 80 or 100 pound bags. Of course, other suitable packaging can be used, such a 55 gallon drum or conventional bulk packaging.

The prepackaged dry component can be transported to a job site where the contents are placed into a mixing vessel such as a bucket or conventional cement mixer and a standardized amount of water is then added to the mixing vessel. The water and dry component are then mixed to produce a colored cement composition in accordance with the present invention. One of the advantages of this method of preparing colored cement is that if additional mortar or grout is need to complete a job, a second or additional package of the dry component can be mixed with a second or additional standardized amounts of water, to obtain a second or additional batch of colored cement that will have a color consistent with the first batch of colored cement.

### DETAILED DESCRIPTION OF PREFERRED EMBODIMENTS

The present invention will be described in detail by reference to the following examples that are provided for illustrative purposes. The following examples should not be construed as limiting the invention. Many variations that do not depart from the spirit or scope of the present invention will suggest themselves to those skilled in the art. All such obvious modifications are within the intended scope of the invention.

### EXAMPLE 1

A brick mortar composition with a uniform beige color is prepared in accordance with the present invention by adding 94 parts by weight of beige Portland cement, 10-100 parts by weight of hydrated lime, 180-240 parts by weight of an earth tone silica sand inert filler, and 73 parts by weight of water to a conventional cement mixer and mixing until a uniform consistency is obtained.

### EXAMPLE 2

A pool plaster composition with a uniform blue color is prepared in accordance with the present invention by adding 94 parts by weight of blue Portland cement, 140 parts by weight of a conventional white calcium carbonate aggregate, a conventional troweling aid commonly known in the industry and 47 parts by weight of water to a conventional cement mixer and mixing until a uniform consistency is obtained. The particle size of the calcium carbonate ranges from 4 to 325 mesh with the average particle size of 60 and up to 20 percent fines that have a particle size of 200 mesh or smaller. Up to 1 weight percent based on the total weight of the pool plaster composition of a polyvinyl alcohol may also be added to the composition to improve the physical properties of the composition if desired.

### EXAMPLE 3

A ceramic tile grout composition with a uniform earth tone color is prepared in accordance with the present invention by adding 30-35 parts by weight of beige Portland cement, 60-65 parts by weight of an earth tone superhydrophobic sand from Clifford W. Estes Co., 0-3 part by weight of a free or non-bonded pigment, 1-5 parts by weight of conventional processing aids and 20 parts by weight of water to a conventional mixer and mixing until a uniform consistency is obtained. The particle size of the super hydrophobic sand ranges from 60-100 mesh and contains approximately 0-5 weight percent fines (particles with a mesh size of 200 or smaller). The more fines present, the less free or non-bonded pigment that is needed for the grout composition.

In order to evaluate the “permanence ” of the dye or pigment bonded to the inert filler, when a pigmented inert filler is to be used, applicants have subjected a number of dyed and pigmented sands to acidic and bleaching. The tests were conducted by immersing 100 grams of pigmented sand in 400 ml of hydrochloric acid (HCl) solutions or sodium hypochlorite (NaOCl) solutions for 48 hours. The temperature of the test solutions was maintained at 100° F. and the sand was not stirred or agitated. After 48 hours, the sand is removed from the test solution, washed with pure water and air dried. The color of the immersed sand is then compared to a sample of the original sand. The results of the tests are reported in Table 1 below:

TABLE 1

| Test Solution | ESTES | SANDTASTIK | SCENIC SANDS* |
|---|---|---|---|
| HCl (20 degrees Baume) | 10 | 6 | 10 |
| HCl (10 degrees Baume) | 10 | 6 | 10 |
| HCl (5 degrees Baume) | 10 | 6 | 10 |
| NaOCl (6%) | 10 | 6 | 10 |
| NaOCl (3%) | 10 | 8 | 10 |
| NaOCl (1.5%) | 10 | 9 | 10 |

(The color of the Estes, Sandtastik and Scenic Sand products tested was teal. A black Scenic Sand product was also tested which gave results similar to that reported above.)

The numbers in the above table are based upon a scale of 1-10, wherein 1 is total color loss and 10 is no color loss.

As demonstrated by the data in Table 1, the pigmented inert filler that is used in the present invention should retain at least 60%, preferably 80% and most preferably 100% of its color after being immersed for 48 hours in concentrated hydrochloric acid and after being immersed for 48 hours in a 6% sodium hypochlorite solution.

We claim

1. A cement composition comprising:
i) colored cement produced from clinkers formed with pigment prior to sintering;
ii) water;
iii) inert filler; and
iv) optionally, conventional additives selected from the group consisting of latexes, setting aids, dispersant, surfactants, liquefiers, reinforcing fibers, preservatives, antifoaming agents, thixotropy and viscosity control agents, plasticizer, freeze thaw stabilizers, flame retardancy or mixtures of the foregoing.

2. The cement composition as defined in claim 1 wherein the inert filler is taken from the group consisting of calcium carbonate, sand, silica sand and crushed stone or marble, having a naturally occurring color.

3. The cement composition as defined in claim 1 wherein the inert filler comprises 0-100 weight percent of a man made pigmented inert filler, wherein the man made pigmented inert filler will maintain at least 60% of its color after being immersed in concentrated hydrochloric acid for forty-eight hours and at least 60% of its color after being immersed in a 6 percent sodium hypochlorite solution for forty-eight hours.

4. The cement composition as defined in claim 3 wherein the pigmented inert filler is taken from the group consisting of sand and silica sand.

5. The cement composition as defined in claim 1 wherein the composition is a pool plaster, stucco, mortar or grout.

6. The cement composition as defined in claim 3 wherein the effective amount of the man made pigmented inert filler is approximately 15-100 weight percent of the total weight of the inert filler.

7. The cement composition as defined in claim 3 wherein man made pigmented inert filler comprises an inert filler that has exhibits superhydrobic properties or wherein a pigment has been bonded to the inert filler by an epoxy linkage.

8. The cement composition as defined in claim 3 wherein the man made pigmented inert filler will maintain at least 80% of its color after being immersed in concentrated hydrochloric acid for forty-eight hours and at least 80% of its color after being immersed in a 6 percent sodium hypochlorite solution for forty-eight hours.

9. A cement composition consisting essentially of:
i) colored cement produced from clinkers formed with pigment prior to sintering;
ii) water;
iii) inert filler; and
iv) optionally, conventional additives selected from the group consisting of latexes, setting aids, dispersant, surfactants, liquefiers, reinforcing fibers, preservatives, antifoaming agents, thixotropy and viscosity control agents, plasticizer, freeze thaw stabilizers, flame retardancy or mixtures of the foregoing.

10. A method for preparing a colored cement composition, said method comprising the steps of:
(a) preparing a colored cement by sintering clinkers comprising a pigment as a component thereof;
(b) mixing water, the colored cement and inert filler; and
(d) optionally, conventional additives selected from the group consisting of latexes, setting aids, dispersant, surfactants, liquefiers, reinforcing fibers, preservatives, antifoaming agents, thixotropy and viscosity control agents, plasticizer, freeze thaw stabilizers, flame retardancy or mixtures of the foregoing.

11. The method for preparing a colored cement composition as defined in claim 10 wherein the inert filler is taken from the group consisting of calcium carbonate, sand, silica sand and crushed stone or marble, having a naturally occurring color.

12. The method for preparing a colored cement composition as defined in claim 10 wherein the inert filler comprises a man made pigmented inert filler, wherein the man made pigmented inert filler will maintain at least 60% of its color after being immersed in concentrated hydrochloric acid for forty-eight hours and at least 60% of its color after being immersed in a 6 percent sodium hypochlorite solution for forty-eight hours.

13. The method as defined in claim 12 wherein the effective amount of the man made pigmented inert filler is approximately 15-100 weight percent of the total weight of the inert filler.

14. The method as defined in claim 12 wherein the man made pigmented inert filler comprises an inert filler that exhibits superhydrophobic properties or wherein a pigment has been bonded to the inert filler by an epoxy or a siloxane linkage.

15. The method as defined in claim 12 wherein the man made pigmented inert filler can maintain at least 80% of its color after being immersed in concentrated hydrochloric acid for forty-eight hours and at least 80% of its color after being immersed in a 6 percent sodium hypochlorite solution for forty-eight hours.

16. A method for preparing a colored cement composition comprising:
(i) selecting a color from a color grid having axes with preselected component colors;
(ii) determining the component colors from the axes of the grid corresponding to the selected color;
(iii) mixing two or more predetermined portions of a colored and/or cement produced from clinkers formed with pigment prior to sintering that correspond to the determined component colors selected from the axis of the color grid; and
(iv) during the mixing of the colored cement produced from clinkers formed with pigment prior to sintering and/or uncolored cement or after the mixing of the colored cement, mixing water and inert filler to obtain a cement composition with the selected color.

17. The composition as defined claim 1 further comprising 0 to 5 weight percent based on the total weight of the composition of non-bonded pigment.

18. The composition as defined in claim 3 wherein the inert filler comprises 0-10 weight percent, based on the total weight of the inert filler, of man made pigmented inert filler fines with a particle size of smaller than 100 mesh.

19. The composition as defined in claim 3 wherein the inert filler comprises 0-10 weight percent, based on the total weight of the inert filler, of man made pigmented inert filler fines with a particle size of smaller than 150 mesh.

20. The composition as defined in claim 3 wherein the inert filler comprises 0-10 weight percent, based on the total weight of the inert filler, of man made pigmented inert filler fines with a particle size of smaller than 200 mesh.

21. The cement composition as defined in claim 9 wherein the inert filler is taken from the group consisting of calcium carbonate, sand, silica sand and crushed stone or marble, having a naturally occurring color or being white.

22. The cement composition as defined in claim 9 wherein the inert filler comprises 0-100 weight percent of a man made pigmented inert filler, wherein the pigmented inert filler will maintain at least 60% of its color after being immersed in concentrated hydrochloric acid for forty-eight hours and at least 60% of its color after being immersed in a 6 percent sodium hypochlorite solution for forty-eight hours.

23. The cement composition as defined in claim 22 wherein the inert filler comprises a man made pigmented inert filler that exhibits superhydrophobic properties or wherein a pigment has been bonded to the inert filler by an epoxy linkage.

24. The cement composition as defined in claim 22 wherein the man made pigmented inert filler will maintain at least 80% of its color after being immersed in concentrated hydrochloric acid for forty-eight hours and at least 80% of its color after being immersed in a 6 percent sodium hypochlorite solution for forty-eight hours.

25. The composition as defined in claim 22 wherein the inert filler comprises 0-10 weight percent, based on the total weight of the inert filler, of man made pigmented inert filler fines with a particle size of smaller than 100 mesh.

26. The composition as defined in claim 22 wherein the inert filler comprises 0-10 weight percent, based on the total weight of the inert filler, of man made pigmented inert filler fines with a particle size of smaller than 150 mesh.

27. The composition as defined in claim 22 wherein the inert filler comprises 0-10 weight percent, based on the total weight of the inert filler, of man made pigmented inert filler fines with a particle size of smaller than 200 mesh.
